(19) United States
(12) Patent Application Publication
(10) Pub. No.: US 2021/0287142 A1
(43) Pub. Date: Sep. 16, 2021

(54) METHOD AND APPARATUS FOR PROCESSING A USER REQUEST

(71) Applicant: Sony Corporation, Tokyo (JP)

(72) Inventors: Gert CEULEMANS, Basingstoke (GB); Francesco CARTELLA, Basingstoke (GB); Erbin LIM, Basingstoke (GB); Gabriel ARMELIN, Basingstoke (GB); Conor Aylward, Basingstoke (GB)

(73) Assignee: Sony Corporation, Tokyo (JP)

(21) Appl. No.: 17/194,367

(22) Filed: Mar. 8, 2021

(30) Foreign Application Priority Data
Mar. 16, 2020 (EP) 20163427.6

(51) Int. Cl. G06N 20/20; G06F 21/56

(52) U.S. Cl. CPC G06N 20/20; G06F 2221/034; G06F 21/566

(57) ABSTRACT

A method for processing a user request is provided. The method includes receiving the user request. Further, the method includes selecting one of a plurality of different machine-learning models. Each of the plurality of machine-learning models is trained for performing the same processing task. The method additionally includes processing the user request using the selected one of the plurality of machine-learning models.

### CROSS-REFERENCE TO RELATED APPLICATION

This application claims priority from EP 20163427.6, filed on Mar. 16, 2020, the contents of which are incorporated by reference herein in its entirety.

### FIELD

The present disclosure relates to data processing using Machine-Learning (ML) models. In particular, examples relate to a method and an apparatus for processing a user request.

### BACKGROUND

In recent years, ML has become an important component for many applications processing user inputs. However, ML models are vulnerable to various cyber-attacks by attackers or fraudsters. For example, attackers try to discover which data sets or parameters (e.g. window sizes) were used to train the ML model by evaluating the ML model's returns for various user inputs. Based on these pieces of information, the attackers, e.g., try to circumvent security measures based on these models or try to make the models output wrong results.

Hence, there may be a desire for improved processing of user requests (inputs) by means of ML models.

### SUMMARY

This desire is met by methods and apparatuses in accordance with the independent claims. Advantageous embodiments are addressed by the dependent claims.

According to a first aspect, the present disclosure provides a method for processing a user request. The method comprises receiving the user request and selecting one of a plurality of different ML models. Each of the plurality of ML models is trained for performing the same processing task. The method further comprises processing the user request using the selected one of the plurality of ML models.

According to a second aspect, the present disclosure provides an apparatus for processing a user request. The apparatus comprises an input interface configured to receive the user request. Further, the apparatus comprises a processing circuitry configured to select one of a plurality of different ML models. Each of the plurality of ML models is trained for performing the same processing task. The processing circuitry is further configured to process the user request using the selected one of the plurality of ML models.

### BRIEF DESCRIPTION OF THE FIGURES

Some examples of apparatuses and/or methods will be described in the following by way of example only, and with reference to the accompanying figures, in which

FIG. 1 illustrates a flow chart of an example of a method for processing a user request;

FIG. 2 illustrates an example of a data flow for processing a user request; and

FIG. 3 illustrates an example of an apparatus for processing a user request.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Same or like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e. only A, only B as well as A and B, if not explicitly or implicitly defined otherwise. An alternative wording for the same combinations is “at least one of A and B” or “A and/or B”. The same applies, mutatis mutandis, for combinations of more than two Elements.

The terminology used herein for the purpose of describing particular examples is not intended to be limiting for further examples. Whenever a singular form such as “a”, “an” and “the” is used and using only a single element is neither explicitly nor implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

FIG. 10 illustrates a flow chart of an example of a method 100 for processing a user request (user input). The method 100 comprises a step 102 of receiving the user request. The user request is a piece of data (e.g. a command with user information or user related information) which asks for a specific service or output from the recipient of the user request. For example, the user request may be a request for access to a service or for an output based on information/data contained in the user request. The user request may originate from any type of user such as an individual user, a company or an organization. The request may be received through a communication network such as Local Area Network (LAN), Wireless LAN (WLAN), a Metropolitan Area Network (MAN), Wide Area Network (WAN) or the internet from an electronic device (e.g. a computer) of the user.

Further, the method 100 comprises a step 104 of selecting one of a plurality of different ML models. Each of the plurality of ML models is trained for performing the same processing task. The processing task is the service or function provided (performed) by each of the plurality of ML models. For example, the service task may be risk assessment of the user request, determination of properties of images included in the user request (e.g. character recognition, detection of picture content) in an image processing and recognition service, or determination of premium discounts in a health monitoring service for a health insurance service. However, it is to be understood that the above listed processing tasks are merely non-limiting examples. In general, the plurality of ML models may perform any other processing task as well. The plurality of ML models may comprise any number N≥2 of ML models.

Further, the method 100 comprises a step 106 of processing the user request using the selected one of the plurality of ML models. In other words, the user request is processed by the selected ML model in order to obtain a processing result for the processing task of the ML model.

The method 100 allows to process the user request according to the processing task. Further, the method 100 may allow to increase the safety for the processing task. Attackers (or fraudsters) try to attack a service using ML models by discovering which data sets or parameters (e.g. windows sizes) were used to train the ML model based on the returns of the ML model. In other words, the attacker attempts to discover the structure of the targeted ML model. Based on this information, the attacker may, e.g., try to circumvent security measures of the ML model or have the model return an incorrect result. In the method 100, a user sending the user request does not know that multiple ML models are available for processing the user request. Further, the user does not know which of the plurality of ML models is actually selected for processing the user request. For a plurality of user requests sent by an attacker to discover the structure of an assumed ML model, the attacker receives returns from different ones of the plurality of ML models according to the method 100. Since the attacker receives returns from different ML models without knowing that multiple ML models are used and without knowing which of them outputs the return for the individual user request, the attacker may be confused. Therefore, the attacker is not able to reconstruct/discover the structure of the individual ML models based on the returns from the different ML models.

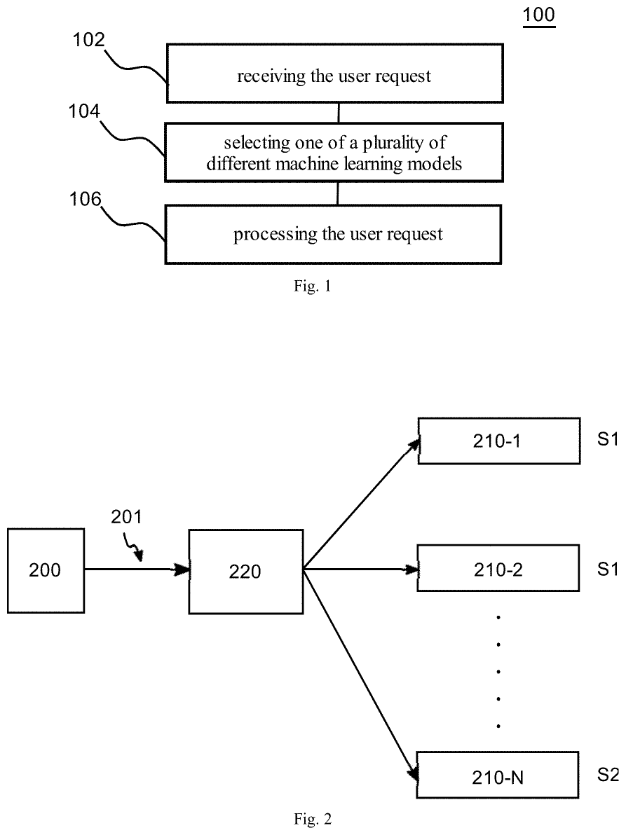

In the following, further details of the method 100 will be described with reference to FIG. 2.

FIG. 2 illustrates an exemplary data flow for processing a user request 201 of a user 200 according to the method 100. In this example, a plurality of different ML models 210-1, 210-2, . . . , 210-N are used

As mentioned above, the plurality of different ML models 210-1, 210-2, . . . , 210-N are configured to perform the same processing task on the user request 201. The ML models 210-1, 210-2, . . . , 210-N may be based on different algorithms such as an XGBoost algorithm, a Long Short-Term Memory (LSTM) algorithm or a logistic regression algorithm. Alternatively or additionally, the ML models 210-1, 210-2, . . . , 210-N may be trained with different parameters.

For the user request 201 received from the user 200, an instance 220 selects one of the plurality of ML models 210-1, 210-2, . . . , 210-N for processing.

For example, the one of the plurality of ML models 210-1, 210-2, . . . , 210-N may be selected based on a predetermined selection scheme such as, e.g., a round robin (scheduling) scheme, a load balancing (scheduling) scheme, a random (scheduling) scheme or a pseudo-random (scheduling) scheme. In other words, the instance 220 may be a switch operating according to a predetermined rule in order to send the user request 201 to one of the ML models 210-1, 210-2, . . . , 210-N for processing.

In other examples, a ML model may be used for the selection of the one of the ML models 210-1, 210-2, . . . , 210-N. For example, selecting the one of the plurality of different ML models may comprise classifying the user request 201 as a regular user request or a malicious user request (i.e. a “normal” or an “attack” user request) using a ML model for classification. Accordingly, the selection of the one of the plurality of different ML models 210-1, 210-2, . . . , 210-N for processing of the user request 201 may be based on the classification of the user request 201. Classification of the user request may, e.g., be based on a user location (region), a sending frequency of user requests from the user or an Internet Protocol (IP) address of the user. However, it is to be noted that the above parameters are merely exemplary and that more, less or other parameters may be used.

Selecting the one of the plurality of different ML models 210-1, 210-2, . . . , 210-N for processing of the user request 201 based on the classification of the user request 201 may allow to select a ML model adapted to the riskiness of the user request. For example, a malicious user request (i.e. a harmful user request) for discovering the structure of an ML model in order to build a ‘shadow model’ at the user-side with similar behaviour may be scheduled to one of the plurality of different ML models 210-1, 210-2, . . . , 210-N with higher latency or more confusing parameters. On the contrary, a regular user request (i.e. a non-harmful user request) may be scheduled to one of the plurality of ML models 210-1, 210-2, . . . , 210-N for regularly processing the user request 201.

The plurality of ML models 210-1, 210-2, . . . , 210-N may be grouped based on their suitability for processing malicious user request or regular user request. For example, two or more subsets of ML models may be used. Accordingly, the selection of the one of the plurality of ML models 210-1, 210-2, . . . , 210-N based on the classification of the user request may comprise selecting, as the selected one of the plurality of ML models 210-1, 210-2, . . . , 210-N, a ML model included in a first subset S1 of the plurality of ML models 210-1, 210-2, . . . , 210-N if the user request 201 is classified as regular user request. For example, the first subset S1 may comprises the ML models 210-1 and 210-2 such that one of them is selected if the user request 201 is classified as regular user request. Similarly, a ML model included in a second subset S2 of the plurality of ML models 210-1, 210-2, . . . , 210-N may be selected as the selected one of the plurality of ML models 210-1, 210-2, . . . , 210-N if the user request is classified as malicious user request. For example, the second subset S2 may comprises the ML model 210-N such that the ML model 210-N is selected if the user request 201 is classified as malicious user request.

However, it is to be understood that the above subsets are merely exemplary and that in other examples more or different subsets may be used. As indicated above, each of the subsets comprises at least one of the plurality of ML models 210-1, 210-2, . . . , 210-N.

For example, the ML model 210-N included in the second subset S2 may exhibit a slower processing time than the ML models 210-1 and 210-2 included in the first subset S1. Accordingly, the processing of a malicious user request may be slowed down, whereas a regular user request may be handled with minimal delay. According to some examples, the processing time of the ML model 210-N included in the second subset S2 may be slower but similar to the processing times of the ML models 210-1 and 210-2 included in the first subset S1 in order to not reveal to an attacker that a special (selected) ML model was used for processing the attacker's user request.

The ML model 210-N included in the second subset S2 may additionally or alternatively be trained with different parameters than the ML models 210-1 and 210-2 included in the first subset S1. For example, the parameters for training the ML model 210-N may be stricter than those for the ML models 210-1 and 210-2. Accordingly, the ML model 210-N may be less vulnerable to malicious user request. In other examples, the ML model 210-N may be trained with parameters that substantially differ from those for the ML models 210-1 and 210-2 such that the ML model 210-N outputs results that substantially differ from those of the ML models 210-1 and 210-2 in order to confuse the attacker.

For example, for a same input, the ML model 210-N of the second subset S2 may be trained to generate a fake (distorted, flawed) output different from outputs of the ML models 210-1 and 210-2 of the first subset S1. By generating fake outputs for malicious user requests, an attacker's shadow training set may be poisoned and, hence, make it difficult or impossible to infer the used ML models or the data sets used for training the models. In other words, a fake output may confuse an attacker's shadow model and therefore make life more difficult for attackers to infer the used ML models or training datasets.

In some examples, a level of maliciousness of the user request 201 may further be determined. For examples, the user request 201 may be assigned to one of two, three or more levels of maliciousness in order to classify the riskiness of the user request 201. The level of maliciousness of the user request 201 may be determined on different parameters such as the user location, the sending frequency of user requests from the user, a type of the user request or the IP address of the user.

If the second subset S2 of the plurality of ML models 210-1, 210-2, . . . , 210-N comprises two or more ML models, the determined level of maliciousness may, e.g., be used for selecting a suitable ML model for processing the user request from the second subset S2 of the plurality of ML models 210-1, 210-2, . . . , 210-N. In other words, the selection of a ML model included in the second subset S2 of the plurality of ML models 210-1, 210-2, . . . , 210-N as the the selected one of the plurality of ML models 210-1, 210-2, . . . , 210-N may be based on the determined level of maliciousness of the user request 201. Accordingly, a ML model suitable for the specific level maliciousness may be selected for processing the user request 201.

The user request 201 is subsequently processed by the selected one of the plurality of ML models 210-1, 210-2, . . . , 210-N in order to perform the predetermined processing task. Information related to an output (return) of the selected one of the plurality of ML models 210-1, 210-2, . . . , 210-N for the user request 201 may be further output (returned) to the user 200 that issued the user request. As described above, if the user 200 is an attacker trying to discover a ML model, the attacker may be confused by the returned information. A regular user may receive a regular return information.

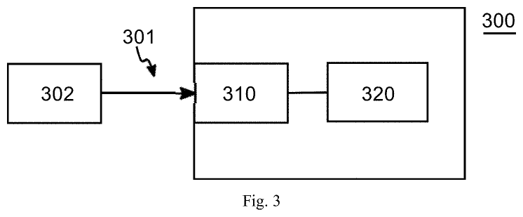

An example of an apparatus 300 for processing a user request according to the proposed technology is illustrated in FIG. 3.

The apparatus 300 comprises an input interface 310 (e.g. implemented as a hardware circuit or as a software interface) configured to receive a user request 301 from a user 302. For example, the apparatus 300 may be coupled to an electronic device of the user 302 (e.g. a computer) via a communication network such as e.g. a LAN, a WLAN, a MAN, a GAN or the internet.

The apparatus 300 further comprises processing circuitry 320 coupled to (with) the input interface 310. For example, the processing circuitry 320 may comprise a single dedicated processor, a single shared processor, or a plurality of individual processors, some of which or all of which may be shared, a digital signal processor (DSP) hardware, an application specific integrated circuit (ASIC) or a field programmable gate array (FPGA). The processing circuitry 320 may optionally be coupled to, e.g., read only memory (ROM) for storing software, random access memory (RAM) and/or non-volatile memory.

The apparatus 300 may further comprise other hardware—conventional and/or custom.

The processing circuitry 320 processes the user request 301 according to the above described technique. That is, the processing circuitry 320 selects one of a plurality of different ML models trained for performing the same processing task and processes the user request 301 using the selected one of the plurality of ML models.

For example, the apparatus 300 may be a server running a service using the processing task. However, the apparatus 300 may as well be any other device providing a service based on ML models.

The apparatus 300 may make it difficult or impossible for an attacker to guess parameters of any of the ML models based on the ML model responses returned to the attacker. Accordingly, the apparatus 300 may make life more difficult for attackers and fraudsters, whereas request of “good” users may be handled with minimum delay. By using ML models with, e.g., different algorithms or parameters, the apparatus 300 may make it harder for an attacker to “game the system”.

The following examples pertain to further embodiments:

(1) A method for processing a user request, the method comprising:

receiving the user request;

selecting one of a plurality of different ML models, wherein each of the plurality of ML models is trained for performing the same processing task; and

processing the user request using the selected one of the plurality of ML models.

(2) The method of (1), wherein the one of the plurality of ML models is selected based on a predetermined selection scheme.

(3) The method of (2), wherein the selection scheme is one of a round robin scheme, a load balancing scheme, a random scheme or a pseudo-random scheme.

(4) The method of (1), wherein selecting the one of the plurality of different ML models comprises:

classifying the user request as regular user request or malicious user request using a machine-learning model for classification; and

selecting the one of the plurality of different ML models based on the classification of the user request.

(5) The method of (1), wherein selecting the one of the plurality of different ML models based on the classification of the user request comprises:

selecting, as the selected one of the plurality of ML models, a machine-learning model included in a first subset of the plurality of ML models if the user request is classified as regular user request; and

selecting, as the selected one of the plurality of ML models, a machine-learning model included in a second subset of the plurality of ML models if the user request is classified as malicious user request.

(6) The method of (5), wherein machine-learning models included in the second subset exhibit a slower processing time than machine-learning models included in the first subset.

(7) The method of (5) or (6), wherein machine-learning models included in the second subset is trained with different parameters than machine-learning models included in the first subset.

(8) The method of any of (5) to (7), wherein, for a same input, at least one machine-learning model of the second subset is trained to generate a fake output different from outputs of the machine-learning models of the first subset.

(9) The method of any of (5) to (8), wherein the method further comprises determining a level of maliciousness of the user request, and wherein selecting, as the selected one of the plurality of ML models, the machine-learning model included in the second subset of the plurality of ML models is based on the determined level of maliciousness of the user request.

(10) The method of any of (1) to (9), further comprising: outputting, to a user issuing the user request, information related to an output of the selected one of the plurality of ML models for the user request.

(11) A non-transitory machine-readable medium having stored thereon a program having a program code for performing the method for processing a user request according to any of (1) to (10), when the program is executed on a processor or a programmable hardware.

(12) A program having a program code for performing the method for processing a user request according to any of (1) to (10), when the program is executed on a processor or a programmable hardware.

(13) An apparatus for processing a user request, the apparatus comprising:

an input interface configured to receive the user request; and processing circuitry configured to:

select one of a plurality of different ML models, wherein each of the plurality of ML models is trained for performing the same processing task; and

process the user request using the selected one of the plurality of ML models.

(14) The apparatus of (13), wherein the processing circuitry is configured to select the one of the plurality of ML models based on a predetermined selection scheme.

(15) The apparatus of (13), wherein the processing circuitry is configured to select the one of the plurality of different ML models by:

classifying the user request as regular user request or malicious user request using a machine-learning model for classification; and

selecting the one of the plurality of different ML models based on the classification of the user request.

(16) The apparatus of (15), wherein the processing circuitry is configured to select the one of the plurality of different ML models based on the classification of the user request by:

selecting, as the selected one of the plurality of ML models, a machine-learning model included in a first subset of the plurality of ML models if the user request is classified as regular user request; and

selecting, as the selected one of the plurality of ML models, a machine-learning model included in a second subset of the plurality of ML models if the user request is classified as malicious user request.

(17) The apparatus of (15), wherein machine-learning models of the second subset exhibit a slower processing time than machine-learning models of the first subset.

(18) The apparatus of any of (15) to (17), wherein, for a same input, at least one machine-learning model of the second subset is trained to generate a fake output different from outputs of the machine-learning models of the first subset.

(19) The apparatus of any of (15) to (18), wherein the processing circuitry is further configured to determine a level of maliciousness of the user request, and wherein the processing circuitry is configured to select, as the selected one of the plurality of ML models, the machine-learning model included in the second subset of the plurality of ML models based on the determined level of maliciousness of the user request.

(20) The apparatus of any of (13) to (19) wherein the apparatus is a server. The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for illustrative purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in a non-transitory machine readable medium (e.g. a floppy disc, a DVD, a Blu-Ray, a CD, a ROM, a PROM, and EPROM, an EEPROM or a FLASH memory) and so executed by a processor or a programmable hardware, whether or not such processor or a programmable hardware is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

What is claimed is:

1. A method for processing a user request, the method comprising:
receiving the user request;
selecting one of a plurality of different machine-learning models, wherein each of the plurality of machine-learning models is trained for performing the same processing task; and
processing the user request using the selected one of the plurality of machine-learning models.

2. The method of claim 1, wherein the one of the plurality of machine-learning models is selected based on a predetermined selection scheme.

3. The method of claim 2, wherein the selection scheme is one of a round robin scheme, a load balancing scheme, a random scheme or a pseudo-random scheme.

4. The method of claim 1, wherein selecting the one of the plurality of different machine-learning models comprises:
classifying the user request as regular user request or malicious user request using a machine-learning model for classification; and
selecting the one of the plurality of different machine-learning models based on the classification of the user request.

5. The method of claim 1, wherein selecting the one of the plurality of different machine-learning models based on the classification of the user request comprises:
selecting, as the selected one of the plurality of machine-learning models, a machine-learning model included in a first subset of the plurality of machine-learning models if the user request is classified as regular user request; and
selecting, as the selected one of the plurality of machine-learning models, a machine-learning model included in a second subset of the plurality of machine-learning models if the user request is classified as malicious user request.

6. The method of claim 5, wherein machine-learning models included in the second subset exhibit a slower processing time than machine-learning models included in the first subset.

7. The method of claim 5, wherein machine-learning models included in the second subset is trained with different parameters than machine-learning models included in the first subset.

8. The method of claims 5, wherein, for a same input, at least one machine-learning model of the second subset is trained to generate a fake output different from outputs of the machine-learning models of the first subset.

9. The method of claims 5, wherein the method further comprises determining a level of maliciousness of the user request, and wherein selecting, as the selected one of the plurality of machine-learning models, the machine-learning model included in the second subset of the plurality of machine-learning models is based on the determined level of maliciousness of the user request.

10. The method of claims 1, further comprising:
outputting, to a user issuing the user request, information related to an output of the selected one of the plurality of machine-learning models for the user request.

11. A non-transitory machine-readable medium having stored thereon a program having a program code for performing the method for processing a user request according to claim 1, when the program is executed on a processor or a programmable hardware.

12. A program having a program code for performing the method for processing a user request according to claim 1, when the program is executed on a processor or a programmable hardware.

13. An apparatus for processing a user request, the apparatus comprising:
an input interface configured to receive the user request; and
processing circuitry configured to:
select one of a plurality of different machine-learning models, wherein each of the plurality of machine-learning models is trained for performing the same processing task; and
process the user request using the selected one of the plurality of machine-learning models.

14. The apparatus of claim 13, wherein the processing circuitry is configured to select the one of the plurality of machine-learning models based on a predetermined selection scheme.

15. The apparatus of claim 13, wherein the processing circuitry is configured to select the one of the plurality of different machine-learning models by:
classifying the user request as regular user request or malicious user request using a machine-learning model for classification; and
selecting the one of the plurality of different machine-learning models based on the classification of the user request.

16. The apparatus of claim 15, wherein the processing circuitry is configured to select the one of the plurality of different machine-learning models based on the classification of the user request by:
selecting, as the selected one of the plurality of machine-learning models, a machine-learning model included in a first subset of the plurality of machine-learning models if the user request is classified as regular user request; and
selecting, as the selected one of the plurality of machine-learning models, a machine-learning model included in a second subset of the plurality of machine-learning models if the user request is classified as malicious user request.

17. The apparatus of claim 15, wherein machine-learning models of the second subset exhibit a slower processing time than machine-learning models of the first subset.

18. The apparatus of claims 15, wherein, for a same input, at least one machine-learning model of the second subset is trained to generate a fake output different from outputs of the machine-learning models of the first subset.

19. The apparatus of claims 15, wherein the processing circuitry is further configured to determine a level of maliciousness of the user request, and wherein the processing circuitry is configured to select, as the selected one of the plurality of machine-learning models, the machine-learning model included in the second subset of the plurality of machine-learning models based on the determined level of maliciousness of the user request.

20. The apparatus of claims 13, wherein the apparatus is a server.
